(19) United States
(12) Patent Application Publication
(10) Pub. No.: US 2025/0207638 A1
(43) Pub. Date: Jun. 26, 2025

(54) BEARING DEVICE STATE DETECTING METHOD, DETECTING DEVICE, AND PROGRAM

(71) Applicant: NSK LTD., Tokyo (JP)

(72) Inventor: Taisuke MARUYAMA, Kanagawa (JP)

(73) Assignee: NSK LTD., Tokyo (JP)

(21) Appl. No.: 18/847,104

(22) PCT Filed: Mar. 7, 2023
(86) PCT No.: PCT/JP2023/008684

§ 371 Date: Nov. 11, 2024

(30) Foreign Application Priority Data
Mar. 14, 2022 (JP) 2022-039416
Mar. 14, 2022 (JP) 2022-039417

(51) Int. Cl. F16C 41/00; G01M 13/04

(52) U.S. Cl. CPC F16C 41/00; G01M 13/04; F16C 2233/00

(57) ABSTRACT

A detection method for detecting a state of a bearing device including a slide bearing includes: applying an AC voltage to an electric circuit including the slide bearing and a rotation shaft; measuring an impedance and a phase angle of the electric circuit when the AC voltage is applied; and deriving an oil film thickness and a metal contact ratio between the slide bearing and the rotation shaft based on the impedance and the phase angle, in which the oil film thickness and the metal contact ratio are derived by using a calculation formula corresponding to an electric circuit constructed by a line contact generated between the slide bearing and the rotation shaft.

### TECHNICAL FIELD

The present invention relates to a detection method, a detection device, and a program for a state of a bearing device.

### BACKGROUND ART

In the related art, in a bearing device, a configuration for lubricating rotation by using a lubricant (for example, a lubricating oil or a grease) is widely used. On the other hand, a rotating component such as a bearing device is periodically subjected to state diagnosis, so that damage or wear is detected at an early stage and occurrence of a failure or the like of the rotating component is suppressed.

In the bearing device using the lubricant, it is required to appropriately detect a state related to the lubricant in order to diagnose an operating state. For example, Patent Literature 1 discloses a method of applying a low DC voltage to a bearing and diagnosing an oil film state of the bearing based on a measured voltage. Further, Patent Literature 2 discloses a method of modeling an oil film as a capacitor, applying an AC voltage to a rotating ring of a bearing in a non-contact state, and estimating an oil film state of a bearing device based on a measured capacitance.

### CITATION LIST

### Patent Literature

Patent Literature 1: Japanese Utility Model Application No. 5-003685
Patent Literature 2: JP4942496B

### SUMMARY OF INVENTION

### Technical Problem

In recent years, there has been a demand for a lower torque for the bearing device. In response to the lower torque, the lubricant used in the bearing device has been reduced in viscosity and oil volume. On the other hand, for example, a larger load is applied to a bearing device used in a large-sized device such as a windmill. In such a situation, the possibility that the oil film inside the bearing device is broken or a contact ratio of components is increased. Therefore, it is required to appropriately detect a contact state between components inside the bearing device in addition to an oil film thickness. There are various types of bearing devices, for example, a slide bearing is included. In such a bearing device, a line contact may occur between a rotation shaft and a peripheral component in association with an operation of the bearing device. For example, according to the technique described in Patent Literature 2, only the oil film thickness is measured, and it is difficult to grasp a metal contact ratio. Since a capacitance outside a contact region was not considered, the measurement accuracy was not high. Further, no measurement was performed on the assumption of the line contact.

In view of the above problems, an object of the present invention is to detect an oil film thickness and a metal contact ratio between components inside a bearing device with high accuracy on the assumption of line contact occurring inside the bearing device.

### Solution to Problem

In order to solve the above problems, the present invention has the following configuration. That is, a detection method for detecting a state of a bearing device including a slide bearing includes:
applying an AC voltage to an electric circuit including the slide bearing and a rotation shaft;
measuring an impedance and a phase angle of the electric circuit when the AC voltage is applied; and
deriving an oil film thickness and a metal contact ratio between the slide bearing and the rotation shaft based on the impedance and the phase angle, in which
the oil film thickness and the metal contact ratio are derived by using a calculation formula corresponding to an electric circuit constructed by a line contact generated between the slide bearing and the rotation shaft in the bearing device.

Another aspect of the present invention has the following configuration. That is, a detection device for detecting a state of a bearing device including a slide bearing includes:
an acquiring unit configured to acquire an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, in which
the deriving unit derives the oil film thickness and the metal contact ratio by using a calculation formula corresponding to an electric circuit constructed by a line contact generated between the slide bearing and the rotation shaft in the bearing device.

Another aspect of the present invention has the following configuration. That is, a program for causing a computer to function as:
an acquiring unit configured to acquire, with respect to a bearing device including a slide bearing, an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, in which
the deriving unit derives the oil film thickness and the metal contact ratio by using a calculation formula corresponding to an electric circuit constructed by a line contact generated between the slide bearing and the rotation shaft in the bearing device.

In order to solve the above problems, the present invention has the following configuration. That is, a detection method for detecting a state of a bearing device including an outer member, an inner member, and a plurality of rollers, includes:
applying an AC voltage to an electric circuit including the outer member, the inner member, and the plurality of rollers in a state in which a predetermined radial load is applied to the bearing device;
measuring an impedance and a phase angle of the electric circuit when the AC voltage is applied; and
based on the impedance and the phase angle, deriving an oil film thickness and a metal contact ratio between the inner member and the plurality of rollers or between the inner member and at least one of the plurality of rollers.

Another aspect of the present invention has the following configuration. That is, a detection device for detecting a state of a bearing device including an outer member, an inner member, and a plurality of rollers, includes:
an acquiring unit configured to acquire an impedance and a phase angle of an electric circuit including the outer member, the inner member, and the plurality of rollers at the time of application of an AC voltage, which are acquired when the AC voltage is applied to the electric circuit, in a state in which a predetermined radial load is applied to the bearing device; and
a deriving unit configured to derive, based on the impedance and the phase angle, an oil film thickness and a metal contact ratio between the inner member and the plurality of rollers or between the inner member and at least one of the plurality of rollers.

Another aspect of the present invention has the following configuration. That is, a program for causing a computer to function as:
an acquiring unit configured to acquire an impedance and a phase angle of an electric circuit including an outer member, an inner member, and a plurality of rollers at the time of application of an AC voltage, which are acquired when the AC voltage is applied to the electric circuit, in a state in which a predetermined radial load is applied to a bearing device including the outer member, the inner member, and the plurality of rollers; and
a deriving unit configured to derive, based on the impedance and the phase angle, an oil film thickness and a metal contact ratio between the inner member and the plurality of rollers or between the inner member and at least one of the plurality of rollers.

### Advantageous Effects of Invention

According to the present invention, it is possible to detect an oil film thickness and a contact ratio between components inside a bearing device with high accuracy on the assumption of line contact occurring inside the bearing device.

### BRIEF DESCRIPTION OF DRAWINGS

FIG. 1 is a schematic diagram showing an example of a device configuration at the time of diagnosis according to a first embodiment of the present invention.

FIG. 2 is a graph showing a physical model of a bearing device according to the first embodiment of the present invention.

FIG. 3 is a circuit diagram for explaining an equivalent circuit of the bearing device according to the first embodiment of the present invention.

FIG. 4 is a diagram for explaining a rolling element (ball) of the bearing device.

FIG. 5 is a diagram for explaining a rotation shaft.

FIG. 6 is a diagram for explaining a slide bearing and the rotation shaft.

FIG. 7 is a diagram for explaining validation results according to the first embodiment of the present invention.

FIG. 8 is a flowchart of a processing at the time of measurement according to the first embodiment of the present invention.

FIG. 9 is a schematic diagram showing an example of a device configuration at the time of diagnosis according to a second embodiment of the present invention.

FIG. 10 is a circuit diagram for explaining an equivalent circuit of a bearing device according to the second embodiment of the present invention.

FIG. 11 is a diagram for explaining a loaded zone and an unloaded zone according to the second embodiment of the present invention.

FIG. 12A is a diagram for explaining capacitances in the loaded zone according to the second embodiment of the present invention.

FIG. 12B is a diagram for explaining the capacitances in the loaded zone according to the second embodiment of the present invention.

FIG. 13 is a circuit diagram for explaining equivalent circuits according to the second embodiment of the present invention.

FIG. 14A is a graph showing measurement results according to the second embodiment of the present invention.

FIG. 14B is a graph showing measurement results according to the second embodiment of the present invention.

FIG. 14C is a graph showing measurement results according to the second embodiment of the present invention.

FIG. 15A is a graph showing measurement results according to the second embodiment of the present invention.

FIG. 15B is a graph showing measurement results according to the second embodiment of the present invention.

FIG. 15C is a graph showing measurement results according to the second embodiment of the present invention.

### DESCRIPTION OF EMBODIMENTS

Hereinafter, embodiments of the present invention will be described with reference to the drawings. The embodiments described below are embodiments for explaining the present invention, and are not intended to be interpreted to limit the present invention, and all the configurations described in the embodiments are not necessarily essential configurations for solving the problem of the present invention. In the drawings, the same components are denoted by the same reference numerals, thereby showing a correspondence relationship therebetween.

### First Embodiment

Hereinafter, a first embodiment of the present invention will be described. In the following description of a device configuration, a slide bearing is described as an example, but the present invention is not limited thereto, and can be applied to devices having other configurations. For example, the present invention can be applied to a rolling device including a component causing a sliding operation to be described later.

### [Device Configuration]

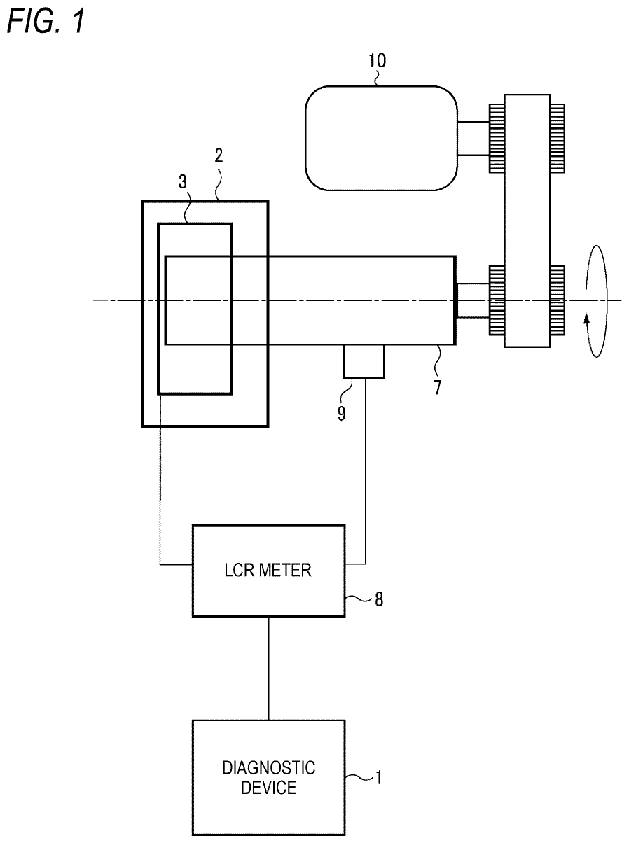

FIG. 1 is a schematic configuration diagram showing an example of an overall configuration when a diagnostic device 1 according to the present embodiment performs diagnosis. In FIG. 1, a bearing device 2 to which a diagnostic method according to the present embodiment is applied and the diagnostic device 1 that performs the diagnosis are provided. The configuration shown in FIG. 1 is an example, and different configurations may be used according to a configuration of the bearing device 2 and the like. Further, although a configuration in which the bearing device 2 includes one slide bearing 3 is shown in FIG. 1, the present invention is not limited thereto, and the bearing device 2 may include a plurality of slide bearings.

The bearing device 2 includes the slide bearing 3. In the bearing device 2, the slide bearing 3 is provided around a rotation shaft 7, and is configured to be rotatable while causing a line contact with the rotation shaft 7. In the slide bearing 3, friction between the rotation shaft 7 and the slide bearing 3 is reduced by a predetermined lubrication method. The lubrication method is not particularly limited, and for example, grease lubrication, oil lubrication, or the like is used and supplied to the inside of the slide bearing 3. A type of a lubricant is also not particularly limited.

A motor 10 is a motor for driving, and supplies power by rotation to the rotation shaft 7. The rotation shaft 7 is connected to an LCR meter 8 via a rotation connector 9. The rotation connector 9 may be configured with, for example, a carbon brush, and is not limited thereto. Further, the slide bearing 3 of the bearing device 2 is also electrically connected to the LCR meter 8, and at this time, the LCR meter 8 also functions as an AC power supply for the bearing device 2.

The diagnostic device 1 operates as a detection device capable of executing a detection method according to the present embodiment. At the time of diagnosis, the diagnostic device 1 instructs the LCR meter 8 to use, as inputs, an angular frequency ω of the AC power supply and an AC voltage V, and acquires, as outputs corresponding thereto, an impedance |Z| (|Z| is an absolute value of Z) and a phase angle θ of the bearing device 2 from the LCR meter 8. Then, the diagnostic device 1 detects an oil film thickness and a metal contact ratio in the bearing device 2 by using these values. Details of the detection method will be described later.

The diagnostic device 1 may be implemented by, for example, an information processing device including a control device, a storage device, and an output device, which are not shown. The control device may include a central processing unit (CPU), a micro processing unit (MPU), a digital single processor (DSP), or a dedicated circuit. The storage device includes volatile and nonvolatile storage media such as a hard disk drive (HDD), a read only memory (ROM), and a random access memory (RAM), and may input and output various kinds of information in response to an instruction from the control device. The output device includes a speaker, a light, or a display device such as a liquid crystal display, and performs notification to an operator in response to an instruction from the control device. A notification method by the output device is not particularly limited, and for example, may be an auditory notification by voice or a visual notification by screen output. The output device may be a network interface having a communication function, and may perform a notification operation by transmitting data to an external device (not shown) via a network (not shown). For example, when abnormality diagnosis is performed based on a detection result, a notification content is not limited to a notification when an abnormality is detected, and may include a notification indicating that the bearing device 2 is normal.

### [Physical Model]

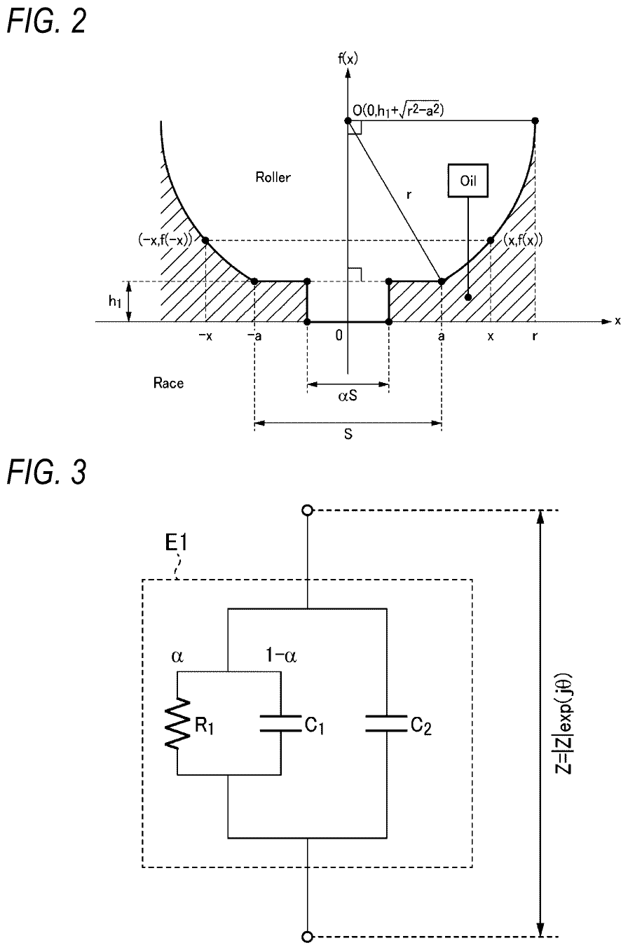

A contact state between the slide bearing 3 of the bearing device 2 and the rotation shaft 7 will be described with reference to FIG. 2. FIG. 2 is a graph showing a physical model when a roller segment and a race segment are in contact (here, the line contact) with each other. The roller segment corresponds to the rotation shaft 7, and the race segment corresponds to the slide bearing 3. An h axis indicates a direction of the oil film thickness, and a y axis indicates a direction orthogonal to the direction of the oil film thickness. Variables shown in FIG. 2 are as follows. In the following description, the same variables in equations are denoted by the same reference numerals to show a correspondence relation.
S: Hertzian contact region
a: contact width in transverse direction (here, x-axis direction) of roller segment (rotation shaft)
α: breakage rate of oil film (metal contact ratio) (0≤α<1)
r: radius of roller segment
αS: actual contact region (breakage region of oil film)
h: oil film thickness
h₁: oil film thickness in Hertzian contact region
O: rotation center of roller segment

In the Hertzian contact region, a ratio of an area in which a metal is in contact to an area in which the metal is not in contact is α: (1−α). In an ideal state in which the roller segment and the race segment are not in contact with each other, α=0, and when x=0, h>0.

The oil film thickness h shown in FIG. 2 is expressed by the following Equation (1). A value of S shown here corresponds to the range in the x-axis direction in FIG. 1.

$$h = f ( x ) = {h}_{1} + √ ( {r}^{2} - {a}^{2} ) - √ ( {r}^{2} - {x}^{2} ) ( - r \leq x < - a or a < x \leq r ) \qquad ( 1 )$$

In addition, in the Hertzian contact region, there may be a thin oil film region called a horseshoe-shaped portion, and in the present embodiment, an average oil film thickness hₐ that is an average oil film thickness in the Hertzian contact region is used. Therefore, when the oil film is broken in the Hertzian contact region, hₐ is obtained by the following Equation (2).

$${h}_{a} = ( 1 - α ) {h}_{1} \qquad ( 2 )$$

In FIG. 2, O is x=0, and coordinates of O in FIG. 2 are represented by O (0, h₁+√(r²−a²)).

Since the rotation shaft 7 may be elastically deformed when the actual slide bearing 3 is operated, a cross section thereof may not have a perfect circular shape in a strict sense, but in the present embodiment, the above Equation (1) is used assuming that the cross section has a perfect circular shape. Therefore, an equation used to acquire the oil film thickness is not limited to Equation (1), and other calculation formulas may be used (for example, an involute curve in the case of a gear).

### [Equivalent Electric Circuit]

FIG. 3 is a diagram showing the physical model shown in FIG. 2 by an electrically equivalent electric circuit (equivalent circuit). An equivalent circuit E1 includes a resistor R₁, a capacitor C₁, and a capacitor C₂. The resistor R₁ corresponds to a resistor in the breakage region (=αS). The capacitor C₁ corresponds to a capacitor formed by an oil film in the Hertzian contact region, and has a capacitance C₁. The capacitor C₂ corresponds to a capacitor formed by an oil film in the vicinity of the Hertzian contact region (−r≤x<−a and a<x≤r in FIG. 2), and has a capacitance C₂. The Hertzian contact region (=S) forms a parallel circuit of the resistor R₁ and the capacitor C₁ in the equivalent circuit E1 of FIG. 3. Further, the capacitor C₂ is connected in parallel to an electric circuit including the resistor R₁ and the capacitor C₁. At this time, it is assumed that the lubricant is filled in the vicinity of the Hertzian contact region (−r≤x<−a, and a<y≤r in FIG. 2).

An impedance of the equivalent circuit E1 is denoted by Z. Here, an AC voltage V applied to the equivalent circuit E1, a current I flowing through the equivalent circuit E1, and a complex impedance Z of the entire equivalent circuit E1 are expressed by the following Equations (3) to (5).

$$V = \vert V \vert exp ( j ω t ) \qquad ( 3 )$$

$$I = \vert I \vert exp ( j ( ω t - θ ) ) \qquad ( 4 )$$

$$Z = V / I = \vert V / I \vert exp ( j θ ) = \vert Z \vert exp ( j θ ) \qquad ( 5 )$$

j: imaginary number
ω: angular frequency of AC voltage
t: time
θ: phase angle (shift in phase between voltage and current)

As shown in Equation (5), the complex impedance Z is represented by two independent variables, that is, the absolute value |Z| of Z and the phase angle θ. This means that two independent parameters (in the present embodiment, hₐ and a shown below) can be measured by measuring the complex impedance Z. The complex impedance Z of the entire equivalent circuit shown in FIG. 3 is expressed by the following Equation (6).

$${Z}^{- 1} = {R}_{1}^{- 1} + j ω ( {C}_{1} + {C}_{2} ) \qquad ( 6 )$$

R₁: resistance value of resistor R₁
C₁: capacitance of capacitor C₁
C₂: capacitance of capacitor C₂
   |Z|: impedance in dynamic contact state

Further, the following Equation (7) and Equation (8) can be derived from Equation (6).

$${R}_{1} = \vert Z \vert / cos θ \qquad ( 7 )$$

$$ω ( {C}_{1} + {C}_{2} ) = - sin θ / \vert Z \vert \qquad ( 8 )$$

Here, since R₁ in Equation (7) has an inverse relation with the contact area, it can be expressed as the following Equation (9).

$${R}_{1} = {R}_{10} / α \qquad ( 9 )$$

R₁₀: resistance value at rest (that is, α=1)

R₁₀ can be expressed by the following Equation (10).

$${R}_{10} = \vert {Z}_{0} \vert / cos {θ}_{0} \qquad ( 10 )$$

   |Z₀|: impedance in static contact state
θ₀: phase angle in static contact state

Therefore, the breakage rate α can be expressed as the following Equation (11) from Equation (7), Equation (9), and Equation (10). When θ₀ is the phase angle in the static contact state as described above, θ can be regarded as a phase angle in the dynamic contact state.

$$\begin{matrix}[ Math . 1 ] & \\ α = \frac{\vert {Z}_{0} \vert cos θ}{\vert Z \vert cos {θ}_{0}} & ( 11 )\end{matrix}$$

On the other hand, C₁ in Equation (6) and Equation (8) can be expressed as the following Equation (12). In a case in which the line contact is assumed, the contact area of the Hertzian contact region S is S=2aL when the length (here, a contact width in a longitudinal direction) of the rotation shaft 7 is L.

$$\begin{matrix}[ Math . 2 ] & \\ {C}_{1} = \frac{ε ( 1 - α ) S}{{h}_{1}} = \frac{2 ε ( 1 - α ) aL}{{h}_{1}} & ( 12 )\end{matrix}$$

ε: dielectric constant of lubricant

Further, C₂ in Equation (6) and Equation (8) can be expressed as the following Equation (13).

$$\begin{matrix}[ Math . 3 ] & \\ {C}_{2} = 2 ε {\int }_{a}^{r} \frac{L d x}{f ( x )} \approx 2 πε L \sqrt{\frac{r}{2 {h}_{1}}} & ( 13 )\end{matrix}$$

### [Capacitance According to Contact State]

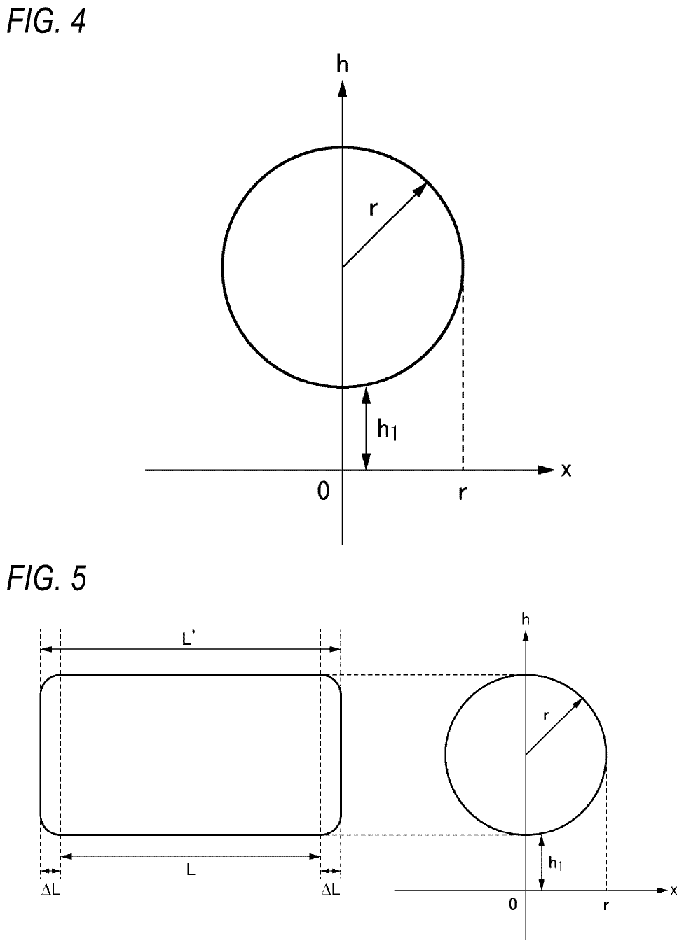

Here, C₂ in a point contact will be described. FIG. 4 is a diagram for explaining a case in which the rolling elements are balls (for example, a ball bearing). Here, a value of h₁ is shown as a large value for ease of description, but actually, as shown in FIG. 2, the value is small enough to generate a contact (the point contact in this case). In this case, the point contact may occur between the rolling elements and a track portion.

Similarly to FIG. 2, when the radius of the rolling element is set to r and the oil film thickness is set to h₁, the capacitance of the capacitor C₂ in the equivalent circuit shown in FIG. 3 can be calculated by the following Equation (14).

$$\begin{matrix}[ Math . 4 ] & \\ {C}_{2} = 2 π ε γ ln ( \frac{r}{{h}_{1}} ) & ( 14 )\end{matrix}$$

π: pi
r: radius of ball
ε: dielectric constant of lubricant
ln: logarithmic function

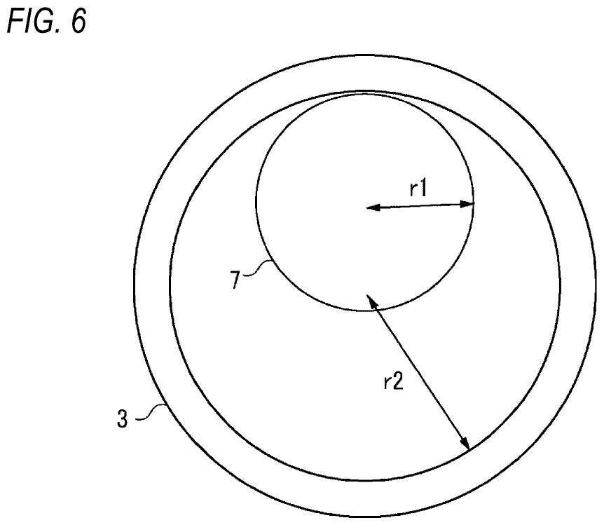

Next, a case in which the line contact to be handled in the present embodiment occurs will be described. FIG. 5 is a diagram for explaining the case of the rotation shaft 7 and the slide bearing 3. Here, similarly to FIG. 4, the value of h₁ is shown as a large value for ease of description, but actually, as shown in FIG. 2, the value is small enough to generate a contact (the line contact in this case). In this case, the line contact may occur between the rotation shaft 7 and the slide bearing 3. As shown in FIG. 6, when a radius of the rotation shaft 7 is set to r1 and a radius of an inner diameter of the slide bearing 3 is set to r2, r can be calculated as an equivalent curvature radius by using r1 and r2. At this time, a surface of the slide bearing 3 on which the line contact with the rotation shaft 7 occurs has a negative curved surface.

An oil film thickness at a position in which the line contact between the rotation shaft 7 and the slide bearing 3 occurs is set to h₁. In this case, the capacitance of the capacitor C₂ in the equivalent circuit shown in FIG. 3 can be calculated by the above Equation (13).

As shown in FIG. 5, the rotation shaft 7 may be formed by chamfering edges. In this case, a straight portion in which the line contact may occur may be handled as L. When a length ΔL in the longitudinal direction due to the chamfering is extremely small with respect to L, the capacitor C₂ may be calculated by using a length L′ (=L+2ΔL) including chamfered portions.

At this time, when the symbols shown in FIGS. 2 and 5 are used, a contact area by the line contact (that is, the contact area of the Hertzian contact region S) can be represented by 2aL.

In addition, the point contact may occur in the chamfered portion instead of the line contact. Therefore, regarding this portion, the capacitor C₂ may be further added to the calculation formula (13) by using the calculation formula (for example, the above Equation (14)) of C₂ caused by the point contact.

An example is shown in which a calculation result of the capacitor C₂ is verified by using a theoretical equation defined by the above Equation (13). Here, a comparison with a result of simulation analysis using a finite element method, which is a known method of electromagnetic field analysis, is shown. In addition, the following Equation (15) by Jackson, which is a known calculation formula, is shown as a comparison target. The equation by Jackson assumes a case in which h₁ is extremely larger than r.

$$\begin{matrix}[ Math . 5 ] & \\ {C}_{2} = \frac{2 π ε L}{ar cosh ( \frac{{h}_{1}}{r} + 2 )} & ( 15 )\end{matrix}$$

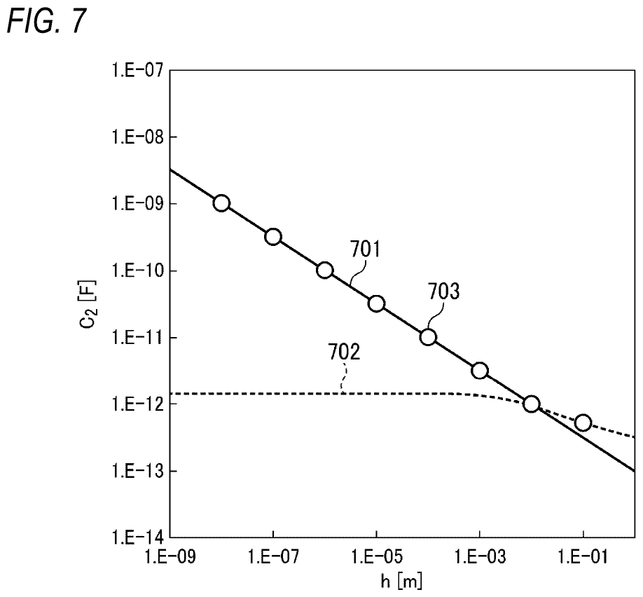

FIG. 7 is a graph showing validation results, the horizontal axis indicates the oil film thickness h₁ [m], and the vertical axis indicates the capacitance C₂ [F]. A line 701 indicates a calculation result of the capacitance C₂ acquired by using Equation (13) which is the calculation formula according to the present embodiment. A line 702 indicates a calculation result of the capacitance C₂ acquired by using Equation (15) which is the calculation formula by Jackson. A symbol 703 (◯) indicates a result acquired by simulation using the finite element method.

As shown by the line 701 and the symbol 703 in FIG. 7, a value of the capacitance C₂ calculated by using Equation (13) can be derived to be substantially the same value as the result of simulation in the range of 1.0⁻²≥h. This range corresponds to the size or the like (h₁ is extremely smaller than r) of the slide bearing 3 assumed in the present invention, and can achieve higher accuracy than the line 702 according to Equation (15) by Jackson.

### [Derivation of Oil Film Thickness and Breakage Rate of Oil Film]

In the present embodiment, a lubrication state is detected by using the oil film thickness h₁ of the lubricant and the breakage rate α of the oil film as described above. The following Equation (16) is derived from Equation (8) and Equations (11) to (13) described above.

$$\begin{matrix}[ Math . 6 ] & \\ {h}_{1} = \frac{8 {( 1 - α )}^{2} {a}^{2}}{r} {( \frac{1 + \sqrt{1 + ψ}}{πψ} )}^{2} & ( 16 )\end{matrix}$$

In this case, ψ is defined as the following Equation (17).

$$\begin{matrix}[ Math . 7 ] & \\ ψ = - \frac{4 ( 1 - α ) a sin θ}{{π}^{2} rL εω \vert Z \vert} & ( 17 )\end{matrix}$$

L: length of rotation shaft

Further, the average oil film thickness hₐ is derived as the following Equation (18) from Equation (2) and Equation (16).

$$\begin{matrix}[ Math . 8 ] & \\ {h}_{a} = \frac{8 {( 1 - α )}^{3} {a}^{2}}{r} {( \frac{1 + \sqrt{1 + ψ}}{πψ} )}^{2} & ( 18 )\end{matrix}$$

That is, hₐ and a can be monitored at the same time by measuring the complex impedance and the phase angle at rest and during oil film formation according to Equation (11) and Equation (18).

The above Equation (18) is a theoretical equation in the case of one contact region.

### [Processing Flow]

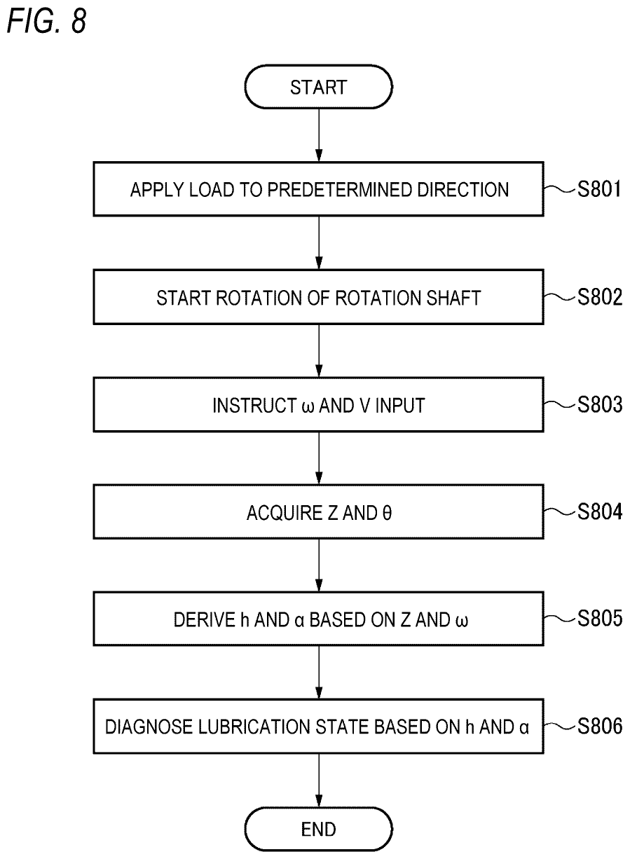

FIG. 8 is a flowchart of a diagnosis processing according to the present embodiment. The processing is executed by the diagnostic device 1, and may be implemented by, for example, reading out a program for implementing the processing according to the present embodiment from the storage device (not shown) and executing the program by the control device (not shown) included in the diagnostic device 1.

In S801, the diagnostic device 1 performs control such that a load is applied to the bearing device 2 in a predetermined direction. In the case of the configuration in FIG. 1, the load is applied to the rotation shaft 7. The control of applying the load may be performed by a device other than the diagnostic device 1. At this time, the phase angle in the static contact state and the impedance are measured.

In step S802, the diagnostic device 1 causes the motor 10 to start rotating the rotation shaft 7. Accordingly, the rotation shaft 7 rotates while the line contact between the rotation shaft 7 and the slide bearing 3 occurs. The motor 10 may be controlled by a device other than the diagnostic device 1.

In step S803, the diagnostic device 1 controls the LCR meter 8 to supply the AC voltage V of the angular frequency ω to the bearing device 2 by using an AC power supply (not shown) included in the LCR meter 8. Accordingly, the AC voltage of the angular frequency ω is applied to the bearing device 2.

In step S804, the diagnostic device 1 acquires the impedance |Z| and the phase angle θ from the LCR meter 8 as the output corresponding to the input in S803. That is, the LCR meter 8 outputs the impedance |Z| and the phase angle θ to the diagnostic device 1 as detection results of the bearing device 2 with respect to the AC voltage V and the angular frequency ω of the AC voltage which are inputs.

In S805, the diagnostic device 1 derives the oil film thickness h (hₐ in the present embodiment) and the breakage rate α by applying, to Equations (11) and (18), the impedance |Z| and the phase angle θ acquired in S804 and the angular frequency ω of the AC voltage used in S803.

In S806, the diagnostic device 1 diagnoses the lubrication state of the bearing device 2 by using the oil film thickness h and the breakage rate α derived in S805. In the diagnostic method here, for example, a threshold may be provided for the oil film thickness h or the breakage rate α, and the lubrication state may be determined based on comparison with the threshold. Then, the processing flow ends.

As described above, according to the present embodiment, it is possible to detect an oil film thickness and a contact ratio between components inside the bearing device with high accuracy on the assumption of line contact occurring inside a rolling bearing.

### Second Embodiment

Hereinafter, a second embodiment of the present invention will be described. In the following description, as the rolling bearing, a cylindrical roller bearing in which a line contact may occur is described as an example, but the present invention is not limited thereto and can be applied to a rolling bearing having other configurations. For example, a method according to the present invention can be applied to a rolling bearing in which a line contact occurs and a device using such a rolling bearing. Further, the present invention is not limited to the bearing, and can also be applied to a device having a configuration in which a line contact to be described later occurs between components lubricated with a lubricant. The description of the same configuration as that of the first embodiment will be omitted, and the description will be given focusing on the difference.

### [Device Configuration]

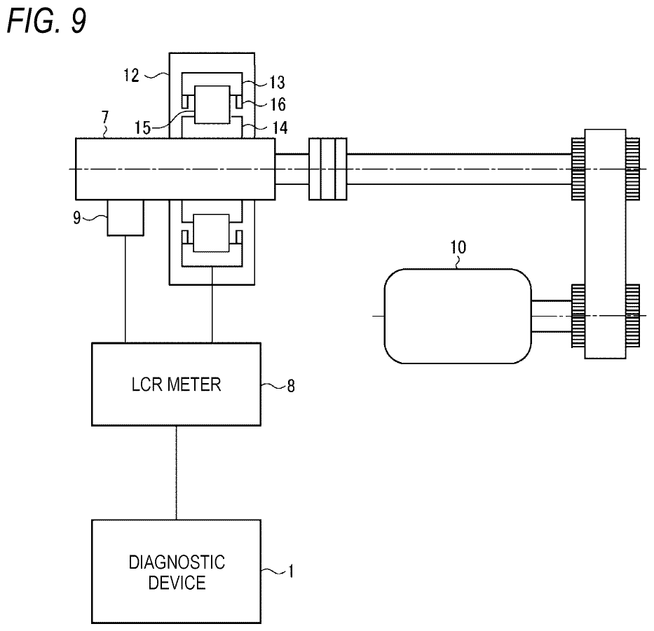

FIG. 9 is a schematic configuration diagram showing an example of an overall configuration when the diagnostic device 1 according to the present embodiment performs diagnosis. In FIG. 9, a bearing device 12 to which the diagnostic method according to the present embodiment is applied and the diagnostic device 1 that performs the diagnosis are provided. The configuration shown in FIG. 9 is an example, and different configurations may be used according to a configuration of the bearing device 2 and the like. Further, although a configuration in which the bearing device 2 includes one rolling bearing is shown in FIG. 9, the present invention is not limited thereto, and one bearing device 2 may include a plurality of rolling bearings. Here, the configuration other than the bearing device 12 is the same as that described in the first embodiment.

In the bearing device 12, the rolling bearing that is a radial type cylindrical roller bearing can rotatably support the rotation shaft 7. The rotation shaft 7 is supported by a housing (not shown) that covers the outside of the rotation shaft 7 via the rolling bearing that is a rotating component. The rolling bearing includes an outer ring (an outer member) 13 which is a fixed ring internally fitted to the housing, an inner ring (an inner member) 14 which is a rotating ring externally fitted to the rotation shaft 7, a plurality of rollers which are a plurality of rolling elements 15 arranged between the inner ring 14 and the outer ring 13, and a retainer (not shown) that retains the rolling elements 15 such that the rolling elements 15 can roll freely. Here, although the configuration in which the outer ring 13 is fixed is used, a configuration in which the inner ring 14 is fixed and the outer ring 13 rotates may be used. In addition, a seal 16 that is a peripheral member for preventing entry of dust into the periphery of the rolling elements 15 and leakage of a lubricating oil is provided. In the rolling bearing, friction between the inner ring 14 and the rolling elements 15 and friction between the outer ring 13 and the rolling elements 15 are reduced by a predetermined lubrication method. The lubrication method is not particularly limited, and for example, grease lubrication, oil lubrication, or the like is used and supplied to the inside of the rolling bearing. A type of the lubricant is also not particularly limited.

### [Physical Model]

A contact state between the rolling elements 15 and the outer ring 13 (or the inner ring 14) in the bearing device 12 will be described with reference to FIG. 2 described in the first embodiment. In the present embodiment, FIG. 2 can be read as a physical model when the roller segment and a ring segment are in contact with each other. The roller segment corresponds to the roller which is the rolling element 15, and the ring segment corresponds to the outer ring 13 (or the inner ring 14). The h axis indicates a direction of the oil film thickness, and the y axis indicates a direction orthogonal to the direction of the oil film thickness. The variables shown in FIG. 2 are as follows. In the following description, the same variables in equations are denoted by the same reference numerals to show a correspondence relation.
S: Hertzian contact region
a: contact width in transverse direction (here, x-axis direction) of roller segment (roller)
α: breakage rate of oil film (metal contact ratio) (0≤α<1)
r: radius of roller segment
αS: actual contact region (breakage region of oil film)
h: oil film thickness
h₁: oil film thickness in Hertzian contact region
θ: rotation center of roller segment

In the Hertzian contact region, a ratio of an area in which a metal is in contact to an area in which the metal is not in contact is α: (1−α). In an ideal state in which the roller segment and the ring segment are not in contact with each other, α=0, and when x=0, h>0.

Next, the case in which the line contact to be handled in the present embodiment occurs will be described with reference to FIG. 5 described in the first embodiment. In the present embodiment, a case in which the rolling elements are rollers (for example, the cylindrical roller bearing) is described. Here, similarly to FIG. 4 described in the first embodiment, the value of h₁ is shown as a large value for ease of description, but actually, as shown in FIG. 2 described in the first embodiment, the value is small enough to generate a contact (the line contact in this case). In this case, the line contact may occur between the rolling elements and the track portion. Similarly to FIG. 2, when the radius of the rolling element is set to r and the oil film thickness is set to h₁, the capacitance of the capacitor C₂ in the equivalent circuit shown in FIG. 3 can be calculated by the above Equation (13).

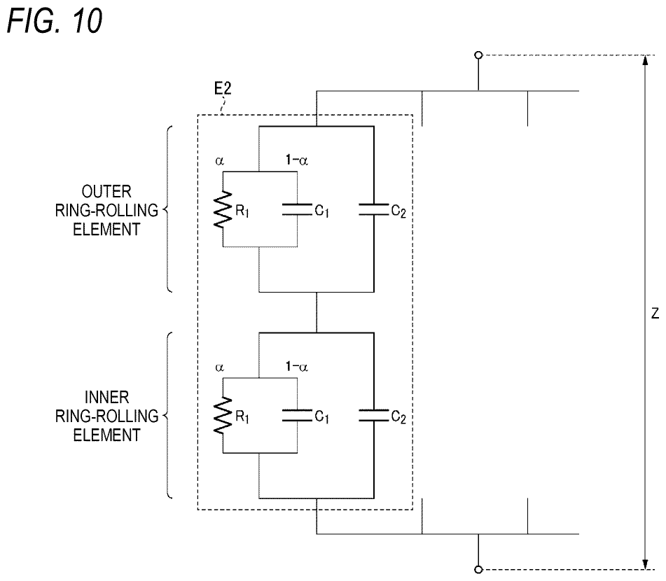

FIG. 10 is a diagram showing an electrically equivalent electric circuit around the rolling elements 15 of FIG. 9 based on the equivalent circuit E1 shown in FIG. 3 described in the first embodiment. Focusing on one rolling element 15 among the plurality of rolling elements 15, an equivalent circuit E2 is formed between the outer ring 13 and the rolling element 15 and between the inner ring 14 and the rolling element 15. Here, it is described that an electric circuit formed by the outer ring 13 and the rolling element 15 is located on an upper side, and an electric circuit formed by the inner ring 14 and the rolling element 15 is located on a lower side, and the locations may be reversed. Around one rolling element 15, these electric circuits, that is, the equivalent circuits E1 in FIG. 3 are connected in series to form the equivalent circuit E2.

### [Capacitance Caused By Radial Load]

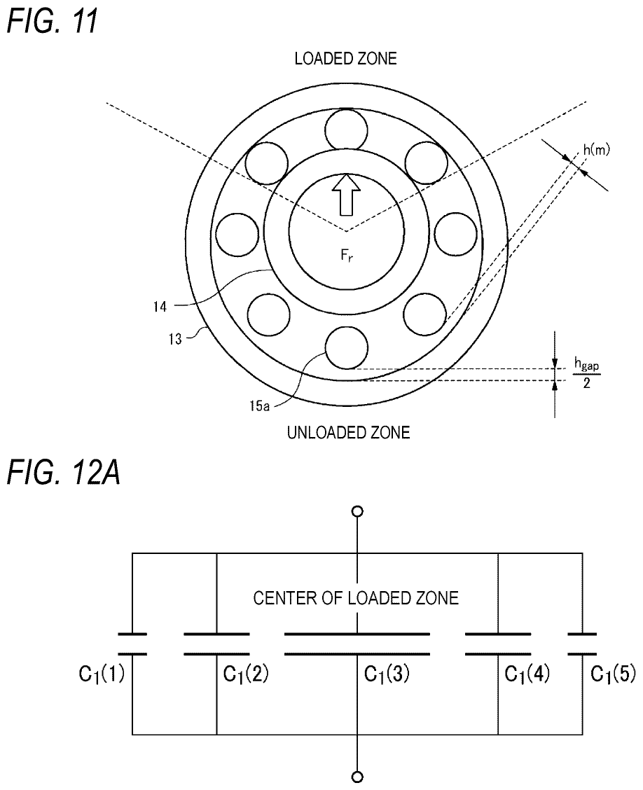

FIG. 11 is a diagram for explaining a loaded zone and an unloaded zone when a radial load is applied to the rolling bearing. Here, it is assumed that a radial load Fᵣ is applied to the rolling bearing via the rotation shaft 7. In this case, in the plurality of rolling elements 15, a range in which the Hertzian contact region as shown in FIG. 2 is generated is referred to as the loaded zone, and the remaining range is referred to as the unloaded zone. The range of the loaded zone may vary according to the magnitude of the radial load, the configuration of the rolling bearing, and the like.

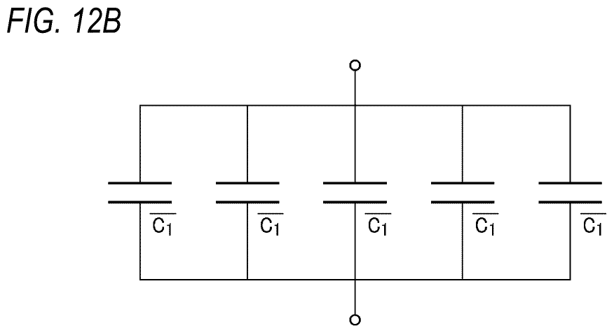

First, the capacitance of the capacitor C₁ in the loaded zone will be described. FIGS. 12A and 12B are diagrams for explaining the concept of the capacitor C₁ formed by the rolling elements 15 located in the loaded zone. Here, an example in which five rolling elements are included in the loaded zone and capacitors C₁(1) to C₁(5) are formed due to the respective rolling elements will be described. In the loaded zone, the size of the Hertzian contact region varies according to the positions of the rolling elements. In this case, as shown in FIG. 12A, it is assumed that the capacitance decreases as a distance from the center increases in the loaded zone.

However, as shown in FIG. 2, it is assumed that the oil film thickness h₁ in the Hertzian contact region is hardly affected by the radial load, and in the present embodiment, the oil film thickness in the loaded zone is constant. Based on the above, as shown in FIG. 12B, the Hertzian contact region S is averaged, and the capacitances of the capacitors C₁ formed by the plurality of rolling elements 15 in the loaded zone are treated as uniform. Therefore, the capacitances of the capacitors C₁ formed by the plurality of rolling elements 15 located in the loaded zone can be derived by the following Equation (19).

$$\begin{matrix}[ Math . 9 ] & \\ {\sum }_{m = 1}^{{n}_{1}} {C}_{1} ( m ) = {n}_{1} \overline{{C}_{1}} & ( 19 )\end{matrix}$$

m: natural number (1≤m≤n₁) indicating rolling elements located in loaded zone
n₁: the number of rolling elements in loaded zone
C₁(m): capacitance in Hertzian contact region of rolling element m
C₁⁻: average value of C₁(m)

Next, a capacitance of a capacitor C₃ in the unloaded zone will be described. In the unloaded zone, a gap between the rolling elements 15 and the outer ring 13 and a gap between the rolling elements 15 and the inner ring 14 are generated. As shown in FIG. 11, when a gap between a rolling element 15a located at the center among the rolling elements 15 located in the unloaded zone and the outer ring 13 and a gap between the rolling element 15a and the inner ring 14 are set as a radial gap h_{gap}, a gap between the outer ring 13 and each of the plurality of rolling elements 15 located in the unloaded zone can be derived from the following Equation (20). Description will be given on the assumption that the gap between the rolling element 15a and the outer ring 13 and the gap between the rolling element 15a and the inner ring 14 are the same (h_{gap}/2). The radial gap h_{gap} can be derived from the radial load Fᵣ and a specification of the rolling bearing or the like.

$$\begin{matrix}[ Math . 10 ] & \\ h ( m ) = \frac{{h}_{gap}}{4} ( 1 - cos ( \frac{2 π m}{n - {n}_{1} + 1} ) ) & ( 20 )\end{matrix}$$

m: natural number (1≤m≤(n−n₁)) indicating rolling elements located in unloaded zone
n: the total number of rolling elements
n₁: the number of rolling elements in loaded zone

Then, a capacitance C₃ of the entire unloaded zone can be derived from the following Equation (21) based on Equation (20).

$$\begin{matrix}[ Math . 11 ] & \\ \sum {C}_{3} = 2 πε L \sqrt{\frac{{R}_{tx}}{{h}_{q a p}}} {\sum }_{m = 1}^{n - {n}_{1}} ( \frac{1}{\sqrt{1 - cos ( \frac{2 π m}{n - {n}_{1} + 1} )}} ) & ( 21 )\end{matrix}$$

m: natural number (1≤m≤(n−n₁)) indicating rolling elements located in unloaded zone
n: the total number of rolling elements
n₁: the number of rolling elements in loaded zone
ε: dielectric constant of lubricant
C₃(m): capacitance in Hertzian contact region of rolling element m
π: pi
L: length of rolling element (roller)
Rₜₓ: effective radius of rolling element (roller)
h_{gap}: radial gap

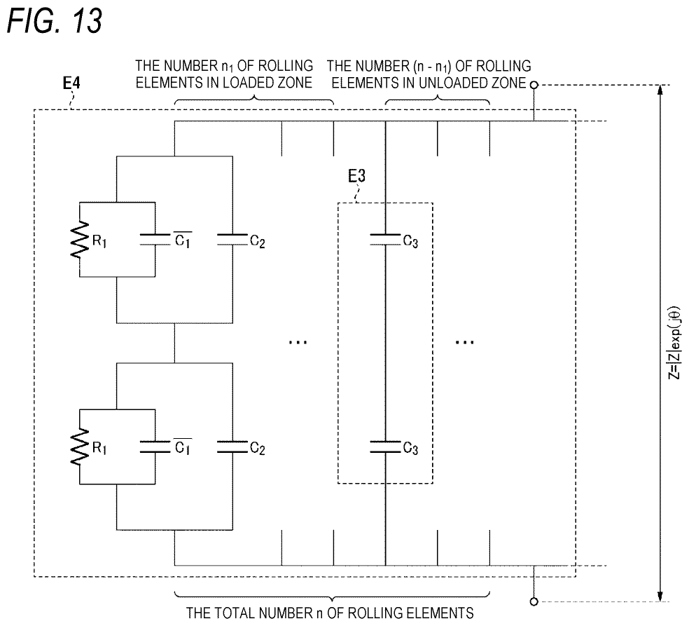

FIG. 13 is a diagram showing an electrically equivalent circuit in the entire bearing device 12 in consideration of the capacitors formed in the loaded zone and the unloaded zone described above. The n equivalent circuits E2 are connected in parallel corresponding to the n rolling elements 15 located in the loaded zone. At this time, as described with reference to FIGS. 12A and 12B, C₁⁻ is used as the capacitance in the Hertzian contact region.

Further, (n−n₁) equivalent circuits E3 are connected in parallel corresponding to the (n−n₁) rolling elements 15 located in the unloaded zone. Since the capacitors are formed between the outer ring 13 and the rolling element 15 and between the inner ring 14 and the rolling element 15 as in the loaded zone, the equivalent circuit E₃ has a configuration in which two capacitors C₃ are connected in series. Here, an electric circuit formed by the outer ring 13 and the rolling element 15 is located on an upper side, and an electric circuit formed by the inner ring 14 and the rolling element 15 is located on a lower side, and the locations may be reversed. Then, the AC power supply functioned by the LCR meter 8 is supplied to an equivalent circuit E4 configured by the entire bearing device 12 shown in FIG. 13 at the time of diagnosis.

### [Derivation of Oil Film Thickness and Breakage Rate of Oil Film]

In the present embodiment, the lubrication state is detected by using the oil film thickness h of the lubricant under the radial load and the breakage rate α of the oil film. In the present embodiment, in order to derive the oil film thickness h of the lubricant under the radial load and the breakage rate α of the oil film, the above Equation (21) and the following Equations (22) to (25) are used.

$$\begin{matrix}[ Math . 12 ] & \\ h = \frac{4 {( 1 - α )}^{3} {\overline{b}}^{2}}{{R}_{tx}} {( \frac{1 + \sqrt{1 + Ψ}}{π Ψ} )}^{2} & ( 22 )\end{matrix}$$

$$\begin{matrix}[ Math . 13 ] & \\ α = \frac{\vert {Z}_{0} \vert cos θ}{\vert Z \vert cos {θ}_{0}} & ( 23 )\end{matrix}$$

$$\begin{matrix}[ Math . 14 ] & \\ Ψ = - \frac{2 ( 1 - α ) \overline{{S}_{t 1}}}{{( π L )}^{2} ε {n}_{1} {R}_{tx}} ( \frac{sin θ}{k ω \vert Z \vert} + \sum {C}_{3} ) & ( 24 )\end{matrix}$$

$$\begin{matrix}[ Math . 15 ] & \\ \overline{{S}_{t 1}} = \frac{1}{{n}_{1}} {\sum }_{m = 1}^{{n}_{1}} \frac{{S}_{i 1} ( m ) + {S}_{o 1} ( m )}{2} = 2 \overline{b} L & ( 25 )\end{matrix}$$

n: the total number of rolling elements (rollers) in bearing
n₁: the number of rolling elements (rollers) in loaded zone
b⁻: average contact width of rolling elements (rollers)
L: length of rolling element (roller)
Rₜₓ: effective radius of rolling element (roller)
Sₜ₁⁻: average contact region
Sₜ₁(m): contact region between rolling element (roller) m and inner ring
Sₒ₁(m): contact region between rolling element (roller) m and outer ring
ω: angular frequency of AC voltage
ε: dielectric constant of lubricant
k: the number of bearings
Ψ: dimensionless constant
h_{gap}: radial gap
m: natural number (1≤m≤(n−n₁)) indicating rolling elements located in unloaded zone
   |Z₀|: impedance in static contact state
θ₀: phase in static contact state
   |Z|: impedance in dynamic contact state
θ: phase in dynamic contact state

In the description with reference to FIG. 2, the contact width of the roller segment is indicated by 2a, but since there are the plurality of rolling elements 15, 2b—which is an average contact width of the plurality of rolling elements 15 is used in the above Equation (25).

The flow of the processing is the same as in the first embodiment. However, in the present embodiment, in S801 of FIG. 8, the diagnostic device 1 performs control such that the radial load Fᵣ is applied to the bearing device 12 in a predetermined load direction. Here, the radial load Fᵣ is applied to the inner ring 14. The control of applying the radial load Fᵣ may be performed by a device other than the diagnostic device 1. At this time, the phase in the static contact state and the impedance are measured.

### [Test 1]

Results of a test performed based on the above diagnostic method will be described. A configuration at the time of the test is based on the configuration shown in FIG. 9, and test conditions are as follows. In Test 1, a bearing provided in a wind turbine generator is used.

### (Test Conditions)

test bearing: cylindrical roller bearing (NU330EM)
the number (n) of rolling elements: 14 (φ45×45)
support bearing: ball bearing (NU2315EM (nameplate: 6315); insulated by a resin sleeve so as not to affect test results of test bearing)
rotation speed: 200 to 1800 [min⁻¹]
axial load: 0 [N]
radial load (Fᵣ): P/C=0.1
lubricant: gear oil VB320 for wind turbine GB
relative dielectric constant: 2.3
AC voltage: 1.1 [V]
frequency of AC power supply: 10 [kHz]
external resistance: 51 [Ω]

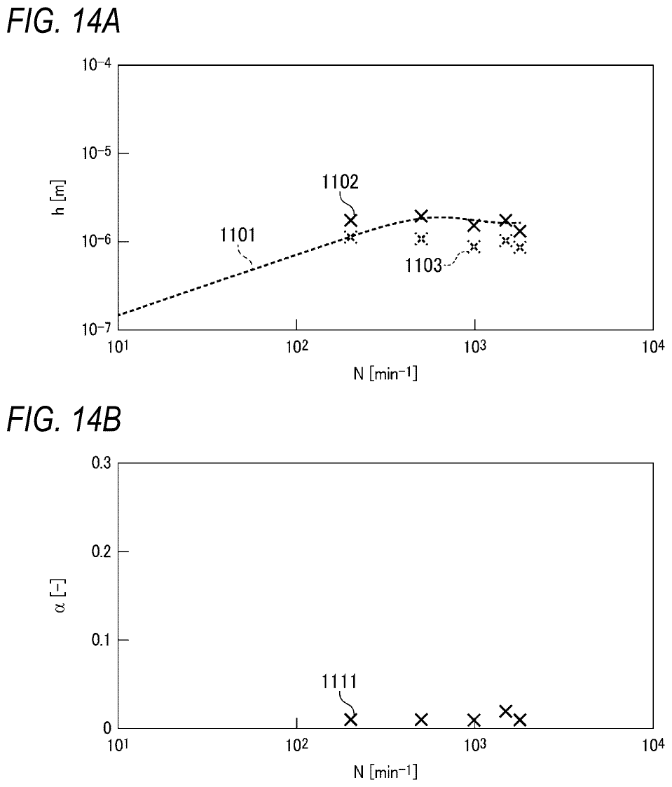

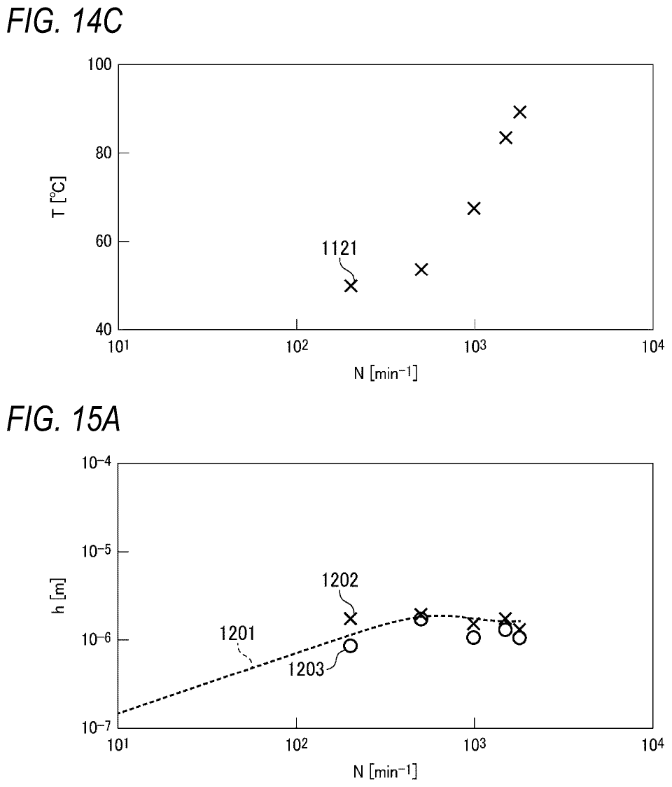

FIGS. 14A to 14C are diagrams showing relations between a rotation speed N and the oil film thickness h, the breakage rate α, and a temperature T acquired from the results of the test performed under the above test conditions. In FIG. 14A, the horizontal axis indicates the rotation speed N [min⁻¹], and the vertical axis indicates the oil film thickness h [m]. In FIG. 14B, the horizontal axis indicates the rotation speed N [min⁻¹], and the vertical axis indicates the breakage rate α. The vertical axis indicates the oil film thickness h [m]. In FIG. 14C, the horizontal axis indicates the rotation speed N [min⁻¹], and the vertical axis indicates the temperature T. In these diagrams, the rotation speed N [min⁻¹] indicated by the horizontal axis corresponds to each other. As described in the above test conditions, results acquired within the range of 200 to 1800 [min⁻¹] of the rotation speed are plotted.

In FIG. 14A, a dashed line 1101 indicates the oil film thickness derived as a theoretical value. A plot 1102 shown by a solid line x indicates a result of the oil film thickness h derived by using the above Equation (22) in consideration of the capacitors C₁, C₂, and C₃. A plot 1103 shown by a dashed line x indicates a result of the oil film thickness h derived by using an equation in consideration of only the capacitors C₁ and C₂. That is, the plot 1102 is a derivation result in consideration of the capacitor C₃ configured in the unloaded zone under the radial load. As shown in FIG. 14A, the result indicated by the plot 1102 is closer to the theoretical value than the result indicated by the plot 1103, and the oil film thickness h can be derived more accurately. Further, as indicated by a plot 1111 in FIG. 14B, the breakage rate α can be derived together with the oil film thickness h at any rotation speed. In addition, even in a case in which a temperature change of the bearing, which is assumed to affect the viscosity of the lubricant, occurs, according to the method, it is possible to restrain the influence and calculate the oil film thickness h and the breakage rate α with high accuracy as compared with a method in the related art.

### [Test 2]

Results of another test performed based on the above diagnostic method will be described. A configuration at the time of the test is based on the configuration shown in FIG. 1, and test conditions are as follows. In Test 2, an influence caused by a collar provided on the outer ring 13 (or the inner ring 14, or both) around a track surface on which the rolling elements 15 roll is considered. Therefore, hereinafter, test results according to the presence or absence of the collar are shown.

### (Test Conditions)

test bearing: cylindrical roller bearing (NU330EM; with collar), cylindrical roller bearing (N330EM; without collar (with resin seat))
the number (n) of rolling elements: 14 (φ45×45)
support bearing: ball bearing (NU2315EM (nameplate: 6315); insulated by a resin sleeve so as not to affect test results of test bearing)
rotation speed: 200 to 1800 [min⁻¹]
axial load: 0 [N]
radial load (Fᵣ): P/C=0.1
lubricant: gear oil VB320 for wind turbine GB
relative dielectric constant: 2.3
AC voltage: 1.1 [V]
frequency of AC power supply: 10 [kHz]
external resistance: 51 [Ω]

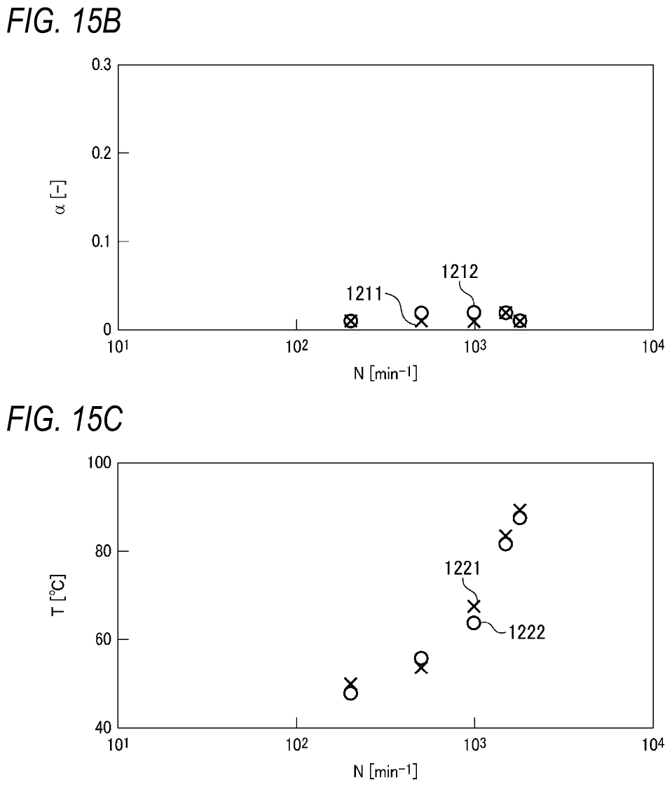

FIGS. 15A to 15C are diagrams showing relations between the rotation speed N and the oil film thickness h, the breakage rate αα, and the temperature T acquired from the results of the test performed under the above test conditions. In FIG. 15A, the horizontal axis indicates the rotation speed N [min⁻¹], and the vertical axis indicates the oil film thickness h [m]. In FIG. 15B, the horizontal axis indicates the rotation speed N [min⁻¹], and the vertical axis indicates the breakage rate α. The vertical axis indicates the oil film thickness h [m]. In FIG. 15C, the horizontal axis indicates the rotation speed N [min⁻¹], and the vertical axis indicates the temperature T. In these diagrams, the rotation speed N [min⁻¹] indicated by the horizontal axis corresponds to each other. As described in the above test conditions, results acquired within the range of 200 to 1800 [min⁻¹] of the rotation speed are plotted.

In FIG. 15A, a dashed line 1201 indicates the oil film thickness derived as a theoretical value. A plot 1202 shown by x indicates a result of the oil film thickness h with respect to the bearing without the collar derived by using the above Equation (22) in consideration of the capacitors C₁, C₂, and C₃. A plot 1203 shown by ◯ indicates a result of the oil film thickness h with respect to the bearing with the collar derived by using the above Equation (22) in consideration of the capacitors C₁, C₂, and C₃. Both of the results are derivation results in consideration of the capacitor C₃ configured in the unloaded zone under the radial load. As shown in FIG. 15A, the results are close to the theoretical value regardless of the presence or absence of the collar on the bearing, and the oil film thickness h can be derived more accurately. Further, as indicated by plots 1211 and 1212 in FIG. 15B, the breakage rate α can be derived together with the oil film thickness h at any rotation speed. In addition, even in the case in which the temperature change of the bearing, which is assumed to affect the viscosity of the lubricant, occurs, according to the method, it is possible to calculate the oil film thickness h and the breakage rate α with high accuracy regardless of the presence or absence of the collar.

As described above, according to the present embodiment, it is possible to simultaneously and accurately detect the oil film thickness and the contact ratio of a slide portion inside a roller bearing device to which the radial load is applied.

### Other Embodiments

In the second embodiment, the radial load is particularly focused on, and the description is given using the radial type bearing in which the radial load is applied. However, by adjusting parameters of the variables, the above equations can also be applied to a thrust type bearing in which an axial load is applied. For example, by adjusting a parameter of Ψ in Equation (22) and (24) based on details of a target bearing, Equation (22) and (24) can also be applied to, for example, a bearing having other configurations in which a line contact occurs.

In the present invention, a program or an application for implementing functions of the one or more embodiments described above may be supplied to a system or a device using a network or a storage medium, and processing in which one or more processors in a computer of the system or the device read and execute the program may be implemented.

In addition, the processing may be implemented by a circuit (for example, an application specific integrated circuit (ASIC) or a field programmable gate array (FPGA)) that implements one or more functions.

As described above, the present invention is not limited to the above embodiments, and combinations of the respective configurations of the embodiments and changes and modifications made by those skilled in the art based on the descriptions in the description and the well-known technique are intended by the present invention and are thus also included within the scope of the present invention to be protected.

As described above, the following matters are disclosed in the present description.
(1) A detection method for detecting a state of a bearing device including a slide bearing includes:
applying an AC voltage to an electric circuit including the slide bearing and a rotation shaft;
measuring an impedance and a phase angle of the electric circuit when the AC voltage is applied; and
deriving an oil film thickness and a metal contact ratio between the slide bearing and the rotation shaft based on the impedance and the phase angle, in which
the oil film thickness and the metal contact ratio are derived by using a calculation formula corresponding to an electric circuit constructed by a line contact generated between the slide bearing and the rotation shaft in the bearing device.

According to the above configuration, it is possible to detect the oil film thickness and the contact ratio between the components inside the bearing device with high accuracy on the assumption of line contact occurring inside the bearing device.
(2) In the detection method according to (1),
the electric circuit constructed by the line contact includes a resistor generated by the line contact, a first capacitor constructed by a lubricant located within a predetermined range from the line contact, and a second capacitor constructed by a lubricant located outside the predetermined range.

According to the above configuration, it is possible to detect the oil film thickness and the contact ratio between the components inside the bearing device with high accuracy based on the equivalent circuit corresponding to the configuration of the bearing device.
(3) In the detection method according to (2),
a capacitance C₁ of the first capacitor is represented by

$${C}_{1} = \frac{2 ε ( 1 - α ) aL}{{h}_{1}} , \qquad [ Math . 16 ]$$

A capacitance C₂ of the second capacitor is represented by

$${C}_{2} = 2 π ε L \sqrt{\frac{r}{2 {h}_{1}}} . \qquad [ Math . 17 ]$$

According to the above configuration, it is possible to accurately derive the capacitance of the capacitor in the equivalent circuit corresponding to the configuration of the bearing device.
(4) In the detection method according to (2) or (3), the calculation formula for deriving the oil film thickness h₁ and the metal contact ratio α includes

$$α = \frac{\vert {Z}_{0} \vert cos θ}{\vert Z \vert cos {θ}_{0}} \qquad [ Math . 18 ]$$

$${h}_{1} = \frac{8 {( 1 - α )}^{2} {a}^{2}}{r} {( \frac{1 + \sqrt{1 + ψ}}{π ψ} )}^{2} \qquad [ Math . 19 ]$$

$$ψ = - \frac{4 ( 1 - α ) a sin θ}{{π}^{2} rL εω \vert Z \vert} \qquad [ Math . 20 ]$$

According to the above configuration, it is possible to detect the oil film thickness and the contact ratio between the components inside the bearing device with high accuracy on the assumption of line contact occurring inside the bearing device.
(5) The detection method according to any one of (1) to (4) further includes diagnosing the bearing device by using the oil film thickness and the metal contact ratio.

According to the above configuration, it is possible to detect the oil film thickness and the contact ratio between the components inside the bearing device on the assumption of line contact occurring inside the bearing device, and perform the state diagnosis of the bearing device with high accuracy based on a detection result.
(6) A detection device for detecting a state of a bearing device including a slide bearing includes:
an acquiring unit configured to acquire an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, in which
the deriving unit derives the oil film thickness and the metal contact ratio by using a calculation formula corresponding to an electric circuit constructed by a line contact generated between the slide bearing and the rotation shaft in the bearing device.

According to the above configuration, it is possible to detect the oil film thickness and the contact ratio between the components inside the bearing device with high accuracy on the assumption of line contact occurring inside the bearing device.
(7) A program for causing a computer to function as:
an acquiring unit configured to acquire, with respect to a bearing device including a slide bearing, an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, in which
the deriving unit derives the oil film thickness and the metal contact ratio by using a calculation formula corresponding to an electric circuit constructed by a line contact generated between the slide bearing and the rotation shaft in the bearing device.

According to the above configuration, it is possible to detect the oil film thickness and the contact ratio between the components inside the bearing device with high accuracy on the assumption of line contact occurring inside the bearing device.

As described above, the following matters are further disclosed in the present description.
(8) A detection method for detecting a state of a bearing device including an outer member, an inner member, and a plurality of rollers, includes:
applying an AC voltage to an electric circuit including the outer member, the inner member, and the plurality of rollers in a state in which a predetermined radial load is applied to the bearing device;
measuring an impedance and a phase angle of the electric circuit when the AC voltage is applied; and
based on the impedance and the phase angle, deriving an oil film thickness and a metal contact ratio between the inner member and the plurality of rollers or between the inner member and at least one of the plurality of rollers.

According to this configuration, it is possible to simultaneously and accurately detect the oil film thickness and the metal contact ratio of the slide portion inside the roller bearing device to which the radial load is applied. In particular, it is possible to accurately perform detection in consideration of the line contact occurring inside the roller bearing device.
(9) In the detection method according to (8), the oil film thickness and the metal contact ratio are derived by using a calculation formula corresponding to each of electric circuits configured in a loaded zone and an unloaded zone in the bearing device specified by the predetermined radial load.

According to this configuration, it is possible to simultaneously and accurately detect the oil film thickness and the contact ratio of the slide portion inside the roller bearing device in consideration of the loaded zone and the unloaded zone caused by the radial load.
(10) In the detection method according to (9), the calculation formula for deriving the oil film thickness h and the metal contact ratio α includes:

$$h = \frac{4 {( 1 - α )}^{3} {\overline{b}}^{2}}{{R}_{t x}} {( \frac{1 + \sqrt{1 + Ψ}}{π Ψ} )}^{2} \qquad [ Math . 21 ]$$

$$α = \frac{\vert {Z}_{0} \vert cos θ}{\vert Z \vert cos {θ}_{0}} \qquad [ Math . 22 ]$$

$$Ψ = - \frac{2 ( 1 - α ) \overline{{S}_{t 1}}}{{( π L )}^{2} ε {n}_{1} {R}_{tx}} ( \frac{sin θ}{k ω \vert Z \vert} + \sum {C}_{3} ) \qquad [ Math . 23 ]$$

$$\sum {C}_{3} = 2 πε L \sqrt{\frac{{R}_{tx}}{{h}_{q a p}}} {\sum }_{m = 1}^{n - {n}_{1}} ( \frac{1}{\sqrt{1 - cos ( \frac{2 π m}{n - {n}_{1} + 1} )}} ) , \qquad [ Math . 24 ]$$

$$and$$

$$\overline{{S}_{t 1}} = \frac{1}{{n}_{1}} {\sum }_{m = 1}^{{n}_{1}} \frac{{S}_{i 1} ( m ) + {S}_{o 1} ( m )}{2} = 2 \overline{b} L . \qquad [ Math . 25 ]$$

According to this configuration, it is possible to simultaneously and accurately detect the oil film thickness and the metal contact ratio of the slide portion inside the roller bearing device to which the radial load is applied. In particular, it is possible to detect the oil film thickness and the metal contact ratio of the slide portion inside the bearing device in consideration of the capacitances corresponding to the loaded zone and the unloaded zone of the rolling bearing in which the line contact occurs.
(11) The detection method according to any one of (8) to (10) further includes diagnosing the bearing device by using the oil film thickness and the metal contact ratio.

According to this configuration, it is possible to diagnose a state related to a lubricant in the rolling bearing based on the oil film thickness and the metal contact ratio specified according to the radial load.
(12) A detection device for detecting a state of a bearing device including an outer member, an inner member, and a plurality of rollers, includes:
an acquiring unit configured to acquire an impedance and a phase angle of an electric circuit including the outer member, the inner member, and the plurality of rollers at the time of application of an AC voltage, which are acquired when the AC voltage is applied to the electric circuit, in a state in which a predetermined radial load is applied to the bearing device; and
a deriving unit configured to derive, based on the impedance and the phase angle, an oil film thickness and a metal contact ratio between the inner member and the plurality of rollers or between the inner member and at least one of the plurality of rollers.

According to this configuration, it is possible to simultaneously and accurately detect the oil film thickness and the contact ratio of the slide portion inside the roller bearing device to which the radial load is applied. In particular, it is possible to accurately perform the detection in consideration of the line contact occurring inside the roller bearing device.
(13) A program for causing a computer to function as:
an acquiring unit configured to acquire an impedance and a phase angle of an electric circuit including an outer member, an inner member, and a plurality of rollers at the time of application of an AC voltage, which are acquired when the AC voltage is applied to the electric circuit, in a state in which a predetermined radial load is applied to a bearing device including the outer member, the inner member, and the plurality of rollers; and
a deriving unit configured to derive, based on the impedance and the phase angle, an oil film thickness and a metal contact ratio between the inner member and the plurality of rollers or between the inner member and at least one of the plurality of rollers.

According to this configuration, it is possible to simultaneously and accurately detect the oil film thickness and the contact ratio of the slide portion inside the roller bearing device to which the radial load is applied. In particular, it is possible to accurately perform the detection in consideration of the line contact occurring inside the roller bearing device.

Although various embodiments have been described above, it is needless to mention that the present invention is not limited to these examples. It is apparent to those skilled in the art that various modified examples or corrected examples are conceivable within the scope recited in the claims, and it is understood to those skilled in the art that the above falls within the technical scope of the present invention. In addition, the components in the above embodiments may be combined in any manner within the scope not departing from the gist of the invention.

The present application is based on Japanese patent applications (No. 2022-039416, No. 2022-039417) filed on Mar. 14, 2022, the contents of which are incorporated herein by reference.

### REFERENCE SIGNS LIST

1 diagnostic device
2 bearing device
3 slide bearing
7 rotation shaft
8 LCR meter
9 rotation connector
10 motor

1: A detection method for detecting a state of a bearing device including a slide bearing, comprising:
applying an AC voltage to an electric circuit including the slide bearing and a rotation shaft;
measuring an impedance and a phase angle of the electric circuit when the AC voltage is applied; and
deriving an oil film thickness and a metal contact ratio between the slide bearing and the rotation shaft based on the impedance and the phase angle, wherein
the oil film thickness and the metal contact ratio are derived by using a calculation formula corresponding to an electric circuit constructed by a line contact generated between the slide bearing and the rotation shaft in the bearing device.

2: The detection method according to claim 1, wherein
the electric circuit constructed by the line contact includes a resistor generated by the line contact, a first capacitor constructed by a lubricant located within a predetermined range from the line contact, and a second capacitor constructed by a lubricant located outside the predetermined range.

3: The detection method according to claim 2, wherein
a capacitance C₁ of the first capacitor is represented by
$${C}_{1} = \frac{2 ε ( 1 - α ) aL}{{h}_{1}} , \qquad [ Math . 1 ]$$
where, ε: dielectric constant of lubricant,
α: breakage rate of oil film (metal contact ratio) (0≤α<1),
a: contact width in transverse direction of rotation shaft,
L: length of rotation shaft, and
h₁: oil film thickness in Hertzian contact region, and
a capacitance C₂ of the second capacitor is represented by
$${C}_{2} = 2 π ε L \sqrt{\frac{r}{2 {h}_{1}}} , \qquad [ Math . 2 ]$$
where, r: radius of roller segment.

4: The detection method according to claim 2, wherein
the calculation formula for deriving the oil film thickness h₁ and the metal contact ratio α includes
$$α = \frac{\vert {Z}_{0} \vert cos θ}{\vert Z \vert cos {θ}_{0}} \qquad [ Math . 3 ]$$
$${h}_{1} = \frac{8 {( 1 - α )}^{2} {a}^{2}}{r} {( \frac{1 + \sqrt{1 + ψ}}{π ψ} )}^{2} , and \qquad [ Math . 4 ]$$
$$ψ = - \frac{4 ( 1 - α ) a sin θ}{{π}^{2} rL εω \vert Z \vert} , \qquad [ Math . 5 ]$$
where, |Z|: impedance in dynamic contact state,

|Z₀|: impedance in static contact state,
θ: phase angle in dynamic contact state,
θ₀: phase angle in static contact state,
ε: dielectric constant of lubricant,
α: breakage rate of oil film (metal contact ratio) (0≤α<1),
a: contact width in transverse direction of rotation shaft,
L: length of rotation shaft,
h₁: oil film thickness in Hertzian contact region,
r: radius of roller segment, and
ω: angular frequency of AC voltage.

5: The detection method according to claim 1, further comprising:
diagnosing the bearing device by using the oil film thickness and the metal contact ratio.

6: A detection device for detecting a state of a bearing device including a slide bearing, comprising:
an acquiring unit configured to acquire an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, wherein
the deriving unit derives the oil film thickness and the metal contact ratio by using a calculation formula corresponding to an electric circuit constructed by a line contact generated between the slide bearing and the rotation shaft in the bearing device.

7: A program for causing a computer to function as:
an acquiring unit configured to acquire, with respect to a bearing device including a slide bearing, an impedance and a phase angle of an electric circuit including the slide bearing and a rotation shaft at the time of application of an AC voltage, which are acquired when the AC voltage is applied to the electric circuit; and
a deriving unit configured to derive, based on the impedance and the phase angle, an oil film thickness and a metal contact ratio between the slide bearing and the rotation shaft, wherein
the deriving unit derives the oil film thickness and the metal contact ratio by using a calculation formula corresponding to an electric circuit constructed by a line contact generated between the slide bearing and the rotation shaft in the bearing device.

8: A detection method for detecting a state of a bearing device including an outer member, an inner member, and a plurality of rollers, comprising:
applying an AC voltage to an electric circuit including the outer member, the inner member, and the plurality of rollers in a state in which a predetermined radial load is applied to the bearing device;
measuring an impedance and a phase angle of the electric circuit when the AC voltage is applied; and
based on the impedance and the phase angle, deriving an oil film thickness and a metal contact ratio between the inner member and the plurality of rollers or between the inner member and at least one of the plurality of rollers.

9: The detection method according to claim 8, wherein
the oil film thickness and the metal contact ratio are derived by using a calculation formula corresponding to each of electric circuits configured in a loaded zone and an unloaded zone in the bearing device specified by the predetermined radial load.

10: The detection method according to claim 9, wherein
the calculation formula for deriving the oil film thickness h and the metal contact ratio α includes:
$${h}_{1} = \frac{4 {( 1 - α )}^{3} {b}^{2}}{{R}_{tx}} {( \frac{1 + \sqrt{1 + ψ}}{π ψ} )}^{2} , \qquad [ Math . 6 ]$$
$$α = \frac{\vert {Z}_{0} \vert cos θ}{\vert Z \vert cos {θ}_{0}} , \qquad [ Math . 7 ]$$
$$Ψ = - \frac{2 ( 1 - α ) \overline{{S}_{t 1}}}{{( π L )}^{2} ε {n}_{1} {R}_{tx}} ( \frac{sin θ}{k ω \vert Z \vert} + \sum {C}_{3} ) , \qquad [ Math . 8 ]$$
$$\sum {C}_{3} = 2 πε L \sqrt{\frac{{R}_{tx}}{{h}_{q a p}}} {\sum }_{m = 1}^{n - {n}_{1}} ( \frac{1}{\sqrt{1 - cos ( \frac{2 π m}{n - {n}_{1} + 1} )}} ) , \qquad [ Math . 9 ]$$
$$and$$
$$\overline{{S}_{t 1}} = \frac{1}{{n}_{1}} {\sum }_{m = 1}^{{n}_{1}} \frac{{S}_{i 1} ( m ) + {S}_{o 1} ( m )}{2} = 2 \overline{b} L , \qquad [ Math . 10 ]$$
where, n: the total number of rolling elements in bearing,
n₁: the number of rolling elements located in loaded zone,
b⁻: average contact width of rolling elements,
L: length of rolling element,
Rₜₓ: effective radius of rolling element,
Sₜ₁⁻: average contact region,
Sᵢ₁(m): contact region between rolling element m and inner ring,
Sₒ₁(m): contact region between rolling element m and outer ring,
ω: angular frequency of AC voltage,
ε: dielectric constant of lubricant,
k: the number of bearings,
Ψ: dimensionless constant,
h_{gap}: radial gap,
m: natural number (1≤m≤(n−n₁)) indicating rolling elements located in unloaded zone,

|Z₀|: impedance in static contact state,
θ₀: phase in static contact state,

|Z|: impedance in dynamic contact state, and
θ: phase in dynamic contact state.

11: The detection method according to claim 8, further comprising:
diagnosing the bearing device by using the oil film thickness and the metal contact ratio.

12: A detection device for detecting a state of a bearing device including an outer member, an inner member, and a plurality of rollers, comprising:
an acquiring unit configured to acquire an impedance and a phase angle of an electric circuit including the outer member, the inner member, and the plurality of rollers at the time of application of an AC voltage, which are acquired when the AC voltage is applied to the electric circuit, in a state in which a predetermined radial load is applied to the bearing device; and
a deriving unit configured to derive, based on the impedance and the phase angle, an oil film thickness and a metal contact ratio between the inner member and the plurality of rollers or between the inner member and at least one of the plurality of rollers.

13: A computer program product comprising a non-transitory computer readable storage medium having instructions encoded thereon that, when executed by a processor, cause the processor to execute process, the process comprising:
acquiring an impedance and a phase angle of an electric circuit including an outer member, an inner member, and a plurality of rollers at the time of application of an AC voltage, which are acquired when the AC voltage is applied to the electric circuit, in a state in which a predetermined radial load is applied to a bearing device including the outer member, the inner member, and the plurality of rollers; and
deriving, based on the impedance and the phase angle, an oil film thickness and a metal contact ratio between the inner member and the plurality of rollers or between the inner member and at least one of the plurality of rollers.
